(19) United States
(12) Patent Application Publication
(10) Pub. No.: US 2022/0143980 A1
(43) Pub. Date: May 12, 2022

(54) FLUID EJECTION HEAD SERVICE WITH NON-WETTING LAYER

(71) Applicant: Hewlett-Packard Development Company, L.P., Spring, TX (US)

(72) Inventors: Chien-Hua Chen, Corvallis, OR (US); Michael G. Groh, Corvallis, OR (US); Glen A. Hopkins, San Diego, CA (US)

(73) Assignee: Hewlett-Packard Development Company, L.P., Spring, TX (US)

(21) Appl. No.: 17/417,862

(22) PCT Filed: Jul. 30, 2019
(86) PCT No.: PCT/US2019/044251

§ 371 Date: Jun. 24, 2021

(51) Int. Cl. B41J 2/165

(52) U.S. Cl. CPC B41J 2/16535

(57) ABSTRACT

A fluid ejection system may include a fluid ejection head having a fluid ejection face through which fluid ejection orifices extend, a media supply to supply a medium for receiving fluid ejected through the fluid ejection orifices and a service station. The service station may include a substrate, an applicator to coat the substrate with a non-wetting layer having a controlled thickness and an actuator to move the substrate with the non-wetting layer into contact with the fluid ejection face without wiping the fluid ejection face.

### BACKGROUND

Fluid ejection heads selectively eject droplet of fluid through orifices in a fluid ejection face. Such fluid ejection heads may be part of a printer which selectively deposits droplets of fluid, in the form of ink, upon a print medium.

### BRIEF DESCRIPTION OF THE DRAWINGS

FIG. 1 is a block diagram schematically illustrating portions of an example fluid ejection system.

FIG. 2 is a flow diagram of an example fluid ejection head service method.

FIG. 3 is a flow diagram of an example fluid ejection head service method.

FIG. 4A is a side view schematically illustrating an example of ejection of fluid through orifices of a fluid ejection face.

FIG. 4B is a side view schematically illustrating an example of coating of a non-wetting layer having a controlled thickness onto an example substrate.

FIG. 4C is a side view schematically illustrating an example of positioning an example fluid ejection head and the example substrate opposite one another.

FIG. 4D is a side view schematically illustrating an example of moving the example fluid ejection face and the example substrate with the example non-wetting layer into contact without relative wiping.

FIG. 4E is a side view schematically illustrating an example of moving the example fluid ejection fare and the example substrate out of contact without relative wiping.

FIG. 4F is a side view schematically illustrating an example of ejection of fluid through orifices and through the applied non-wetting layer on the fluid ejection face.

FIG. 4G is a side view schematically illustrating an example of advancing a web providing the example substrate to position an example second substrate opposite an example non-wetting material applicator.

FIG. 4H is a side view schematically illustrating an example of coating the example second substrate with a second non-wetting layer having a controlled thickness.

FIG. 4I is a side view schematically illustrating an example of positioning the example fluid ejection head with the previously applied non-wetting layer and the second substrate with the second non-wetting layer opposite one another.

FIG. 4J is a side view schematically illustrating positioning of the second non-wetting layer on the second substrate and the non-wetting layer on the fluid ejection face into contact without relative wiping.

FIG. 4K is a side view schematically illustrating an example of separating the example fluid ejection head from the second substrate and the second non-wetting layer.

FIG. 4L is a side view schematically illustrating an example of ejection of fluid through the fluid ejection orifices of the fluid ejection head.

FIG. 5A is a top view schematically illustrate portions of an example fluid ejection system.

FIG. 5B is a side view schematically illustrating portions of the example fluid ejection system of FIG. 5A with an example fluid ejection head positioned opposite an example purging and wiping station of an example fluid ejection head service station.

FIG. 5C is a top view of the example fluid ejection system with the example fluid ejection head positioned opposite to an example non-wetting layer application station of the example fluid ejection head service station.

FIG. 5D is a side schematically illustrating portions of the example fluid ejection system of FIG. 5C during coating of an example substrate with a non-wetting layer of controlled thickness.

FIG. 5E is a side view schematically illustrating portions of the example fluid ejection system of FIG. 5D with the example fluid ejection head and the example substrate with the example non-wetting layer positioned opposite one another.

FIG. 5F is a side view schematically illustrating portions of the example fluid ejection system of FIG. 5E with the example non-wetting layer and an example fluid ejection face of the example fluid ejection head being moved into contact without relative wiping.

FIG. 6 is a side view of an example non-wetting material thinner of the system of FIG. 5F.

FIG. 7 is a side view of an example non-wetting material thinner of the system of FIG. 5F.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Over time, the fluid ejection face and the orifices of a fluid ejection head may become contaminated or acquire an energy state (fluid philic or phobic characteristic) that may cause puddling of fluid on the fluid ejection face. Such contamination or puddling may lead to inconsistent droplet size and inconsistent fluid ejection. Such contamination or puddling may lead to poor ejection or print quality.

Disclosed are example fluid ejection systems, fluid ejection service stations and fluid ejection head service methods that enhance fluid ejection consistency and quality by periodically coating the fluid ejection face with a non-wetting layer, a fluid phobic layer. Such periodic or repeated servicing of the fluid ejection face with the non-wetting layer may reduce contamination and puddling issues with the fluid ejection face throughout the life of the fluid ejection head.

The example fluid ejection systems, fluid ejection service stations and fluid ejection head service methods apply the non-wetting layer to the fluid ejection face in a manner such that the coating has a controlled thickness and is less likely to smear into the orifices. In particular, a non-wetting layer having a controlled thickness is first coated upon a substrate in the service station and the coated substrate is then brought into contact with the fluid ejection face without wiping the fluid ejection face. “Wiping” generally refers to the sideways relative movement of the face of the substrate and the fluid ejection face while the substrate face and the fluid ejection face, or materials carried by the substrate face and the fluid ejection face, are in contact with one another. In implementations where the fluid ejection face faces in a vertical direction, the coated substrate is vertically moved into contact with the fluid ejection face, wherein the coating upon the substrate is stamped onto the fluid ejection face. The coating upon the substrate is permitted to adhere or cling to the fluid ejection face. Following such contact, the substrate and any remaining coating upon the substrate are likewise withdrawn from the fluid ejection face without smearing fluid into the orifices.

In some implementations, the substrate may be provided in the form of a web of non-absorbent material, such as Mylar. The web may be wound and unwound such that clean or unused portions of the web are coated with the non-wetting layer and brought into contact with the fluid ejection face each time that the fluid ejection face is being serviced or different portions of the fluid ejection face are being serviced with the application of the non-wetting layer. Because an unused substrate coated with the non-wetting layer is used each servicing instance, the likelihood of the fluid ejection face being contaminated with fluid deposited upon the substrate from a prior servicing instance is reduced.

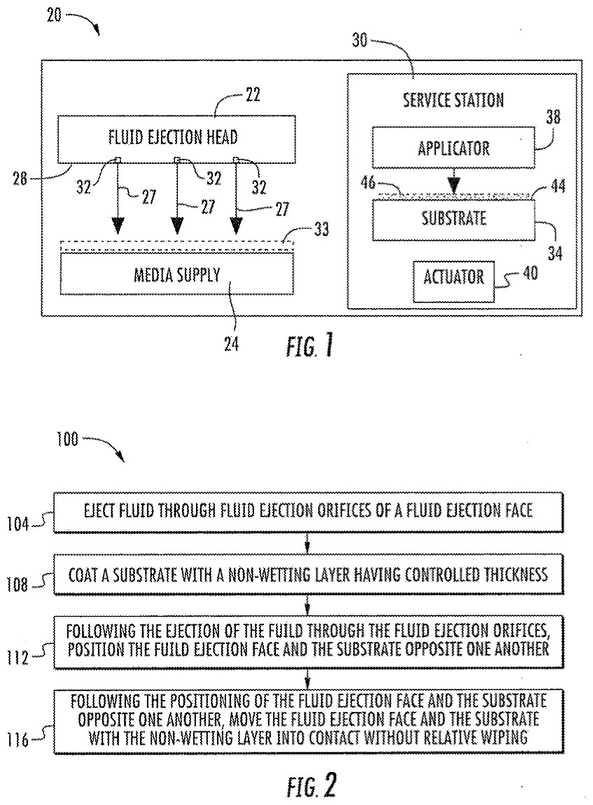

FIG. 1 schematically illustrates portions of an example fluid ejection system 20. Fluid ejection system 20 enhances fluid ejection consistency and quality by periodically coating the fluid ejection face with a non-wetting layer, a fluid phobic layer. Such periodic repeated servicing of the fluid ejection face with the non-wetting layer may reduce contamination and puddling issues with the fluid ejection face throughout the life of the fluid ejection head. Fluid ejection system 20 applies the non-wetting layer to the fluid ejection face in a manner such that the coating has a controlled thickness and is less likely to smear into the orifices. Fluid ejection system 20 comprises fluid ejection head 22, media supply 24, and service station 30.

Fluid ejection head 22 comprises a structure that provides controlled ejection of fluid, such as ink, onto a medium, such as a sheet or web of material, as indicated by arrows 27. Fluid ejection head 22 comprises a fluid ejection face 28 through which fluid ejection nozzles or orifices 32 extend. In one implementation, fluid ejection head 22 comprises fluid ejection chambers adjacent the ejection orifices and fluid actuators that displace fluid within the ejection chambers to eject fluid through the orifices 32. Although fluid ejection head 22 is illustrated as comprising three orifices 32, it should be appreciated that head 22 may comprise a greater or fewer number of such orifices 32. For example, fluid ejection head 22 may comprise a two dimensional array of orifices for ejecting similar or dissimilar fluids. In one implementation, different sets of the orifices 32 may be provided for the controlled ejection of different colors of ink.

In one implementation, the fluid actuators to eject fluid may each comprise a thermal resistor which, upon receiving electrical current, heats to a temperature above the nucleation temperature of the fluid so as to vaporize a portion of the adjacent fluid to create a bubble which displaces the fluid through the associated orifice 32. In other implementations, the fluid actuator may comprise other forms of fluid actuators. In other implementations, the fluid actuator may comprise a fluid actuator in the form of a piezo-membrane based actuator, an electrostatic membrane actuator, mechanical/impact driven membrane actuator, a magnetostrictive drive actuator, an electrochemical actuator, and external laser actuators (that form a bubble through boiling with a laser beam), other such microdevices, or any combination thereof.

In one implementation, fluid ejection head 22 may be movably supported by a carriage, wherein fluid ejection head 22 is scanned across a medium provided by media supply 24. In yet another implementation, fluid ejection head 22 may be part of a single head or a group of heads that collectively span the medium provided by media supply 24. For example, in one implementation, fluid ejection head 22 may be part of a page-wide-array head.

Media supply 24 supplies a medium 33 for receiving the fluid ejected from fluid ejection head 22. In one implementation, media supply 24 comprise a series of rollers that pick and move sheets of media along a media path, a portion of which is situated opposite to fluid ejection head 22. In another implementation, media supply 24 may comprise a supply roll and a take up roll for supporting a web of the medium that is to receive fluid ejected from fluid ejection head.

Service station 30 periodically treats or services fluid ejection head 22 between printing operations to prolong the life and performance of fluid ejection head 22. Service station 30 enhances fluid ejection consistency and quality by periodically coating the fluid ejection face with a non-wetting layer, a fluid phobic layer. Service station 30 comprises substrate 34, applicator 38 and actuator 40.

Substrate 34 comprise a structure providing a surface 44 upon which a coating or layer 46 of a non-wetting material may be deposited or otherwise formed. For purposes of this disclosure, a non-wetting material, forming the non-wetting layer 46, comprises a material that is fluid phobic, resisting or repelling fluid. A non-wetting material is a low surface energy material that lacks attraction to a mass of the fluid that is to be ejected from head 22. A non-wetting material is a material that has a contact angle of greater than 90 with respect to the fluid to be ejected by fluid ejection head 22.

In the example illustrated, the surface 44 of substrate 34 that receives the non-wetting material is nonabsorbent. In one implementation, the surface of substrate 34 is formed from Mylar. In other implementations, the surface 44 may comprise other nonabsorbent materials such as polyethylene, nylon, polyimide, and so on. In one implementation, surface 44 may be provided as part of a stationary structure or platform. In another implementation, surface 44 may be provided by a web of material supplied from a supply roll and taken up by a take up roll.

Applicator 38 comprises a mechanism to controllably deposit the non-wetting material upon surface 44 to form the non-wetting layer 46 having a controlled thickness. The thickness of layer 46 is controlled such that layer 46, when stamped against fluid ejection face 28, does not fill or enter orifices 32. In one implementation, applicator 38 provides the non-wetting layer 46 with a thickness of no greater than 3 μm. In one implementation, applicator 38 provides the non-wetting layer 46 with a thickness of no greater than 1 μm. In one implementation, applicator 30 provides a non-wetting layer 26 having a thickness of no greater than 1/10 of an average diameter of the orifices 32. In one implementation in which the orifice openings have an average diameter of 25 micrometres, applicator 38 provides layer 46 with the controlled thickness of no greater than 1 μm.

In one implementation, applicator 38 may comprise a dispenser or wet wipe which deposits a dose or mass of liquid wetting material onto surface 44 and a thinner that controls the thickness of the formed non-wetting layer. The thinner may be in the form of a doctor blade or pressure roller spaced from the surface 44 by a predefined distance corresponding to the controlled thickness of the non-wetting layer 46. In other implementations, the dispenser itself may form layer 46 with the controlled thickness, without use of a thinner.

Actuator 40 comprises a mechanism operably coupled to substrate 34 and/or fluid ejection head 22 so as to move the substrate 34 with the non-wetting layer 46 and the fluid ejection face 28 of fluid ejection head 22 into contact with one another without wiping the fluid ejection face 28. Said another way, actuator 40 comprises a mechanism that moves substrate 34 and/or fluid ejection head 22 in directions perpendicular to one another such that fluid ejection face 28 is stamped with the non-wetting layer 46 supported on substrate 34. In one implementation, actuator 40 moves fluid ejection head 22 relative to substrate 34 to provide such stamping. In another implementation, actuator 40 moves substrate 34 relative to fluid ejection head 22 to provide such stamping. In yet another implementation, actuator 40 moves both fluid ejection head 22 and substrate 34 towards one another to provide such stamping. Due the controlled thickness of layer 46 and such stamping transfer, the fluid ejection face 28 is coated with new or additional non-wetting material without the non-wetting material becoming wiped, smeared or otherwise deposited into orifices 32. Following such stamping, the fluid ejection face 28 and the substrate 34 are likewise separated from one another without the non-wetting material becoming wiped, smeared or otherwise deposited into orifices 32.

FIG. 2 is a flow diagram of an example fluid ejection head service method 100 for servicing a fluid ejection head following the use of fluid ejection head to deposit fluid upon a medium. Although method 100 is described in the context of being carried out by system 20, it should be appreciated that method 100 may likewise be carried out with any of the fluid ejection systems described hereafter or with other fluid ejection systems having a service station similar to service station 30. As indicated by block 104, a printing or other fluid ejection operation is carried out where fluid is ejected through an orifice 32 or multiple orifices 32 along fluid ejection face 28. In one implementation, the fluid is ejected through orifices 32 onto medium 33 supported by media supply 24.

As indicated by block 108, applicator 38 coats surface 44 of substrate 34 with a non-wetting layer 46 having a controlled thickness. Such coating of surface 44 may occur concurrently with, before or after the ejection of fluid in block 104. In one implementation, surface 44 is coated with layer 46 after the ejection of fluid in block 104 and immediately prior to the servicing of fluid ejection face 28 (without any intervening fluid ejections through orifices 32 onto medium 33) so as to reduce evaporation or drying solidification of layer 46 prior to application of the non-wetting material of layer 46 to face 28.

As indicated by block 112, following the ejection of the fluid through the fluid ejection orifices per block 104, the fluid ejection face 28 and the substrate 34, supporting layer 46, are positioned opposite to one another. In one implementation, the fluid ejection head 22 may be moved such that face 28 is opposite to substrate 34. In one implementation, substrate 34 is moved such that face 44 and layer 46 are opposite to face 28 of fluid ejection head 22. In yet another implementation, both fluid ejection head 22 and substrate 34 are moved relative to one another to position layer 46 and face 44 of substrate 34 directly opposite to face 28 of fluid ejection head 22.

As indicated by block 116, following the positioning of the fluid ejection face 28 and face 44 of substrate 34 opposite to one another per block 112, the fluid ejection face 28 and the substrate 34, along with the non-wetting layer 46, are moved into contact with one another without relative wiping. In one implementation, layer 46 is moved into contact with surface 42 without movement of face 28 or layer 46 in a plane parallel to the plane of face 28 or the plane of surface 41. In one implementation, surface 28 and layer 46 are moved towards one another in directions perpendicular to fluid ejection face 28 and/or surface 44 of substrate 34. The controlled thickness of layer 46 and the non-wiping contact of face 28 and layer 46 are such that the extent to which the non-wetting material of layer 46 is pushed into or enters orifices 32 is reduced.

FIG. 3 is a flow diagram of an example fluid ejection head service method 200 which is carried out following method 100 described above. Methods 100 and 200 illustrate a larger overall fluid ejection and fluid ejection head servicing regimen. Method 200 illustrates how fluid ejection head 22, following servicing or treatment in block 116, may be separated from substrate 34 and readied for further fluid ejection without deposition of non-wetting material into orifices 32. Method 200 further illustrates how the surface 28 may be refurbished with new non-wetting material to replace any non-wetting material previously applied in block 116 that may have worn away or otherwise been removed from face 28. As with method 100, method 200 is described in the context of being further carried out by system 20. It should be appreciated that method 200 may likewise be carried out with any of the fluid ejection systems described hereafter or with other fluid ejection systems having a service station similar to service station 30.

As indicated by block 220, following block 116 (shown in FIG. 2), fluid ejection face 28 and substrate 34 are moved out of contact without relative wiping. In one implementation, layer 46 is moved out of contact with surface 42 without movement of face 28 or layer 46 in a plane parallel to the plane of face 28 or the plane of surface 44. In one implementation, surface 28 and layer 46 are moved away from one another in directions perpendicular to fluid ejection face 28 and/or surface 44 of substrate 34. The non-wiping withdrawal of face 28 and layer 46 from one another are such that the extent to which the non-wetting material of layer 46 is pushed into or enters orifices 32 is reduced.

Blocks 224, 228, 232 and 236 are similar to blocks 104, 108, 112 and 116, respectively, except that such blocks represent a second fluid ejection and servicing operation. In the example illustrated, the ejection of fluid in block 224 may comprise the ejection of fluid onto and partially over the fluid previously ejected onto medium 33, may comprise the ejection of fluid onto a different portion of medium 33 or may comprise ejection fluid onto a different medium 33 (onto a different sheet or a different portion of a web). The second fluid may be the same type of fluid as ejected in block 104 or may be a different type or color of fluid as ejected in block 104. As with the servicing carried out in blocks 108, 112 and 116, the second subsequent servicing carried out in blocks 228, 232 and 236 forms a layer of the non-wetting material on face 28, wherein the extent to which the non-wetting material of the layer that enters orifices 32 is reduced.

In some implementations, the non-wetting material applied to surface 28 in block 236 is deposited on top of or over portions of the remaining non-wetting material previously formed in block 116. As a result, the non-wetting material deposited or applied upon surface 28 in block 236 replaces any non-wetting material that may have been wiped away or removed since the application of non-wetting material in block 116. Because the fluid ejection and servicing operations set forth in blocks 104-116 and 220-236 may be repeated during the life of the fluid ejection system 20, the quality or consistency of fluid ejection by fluid ejection system 20 during its life may be enhanced.

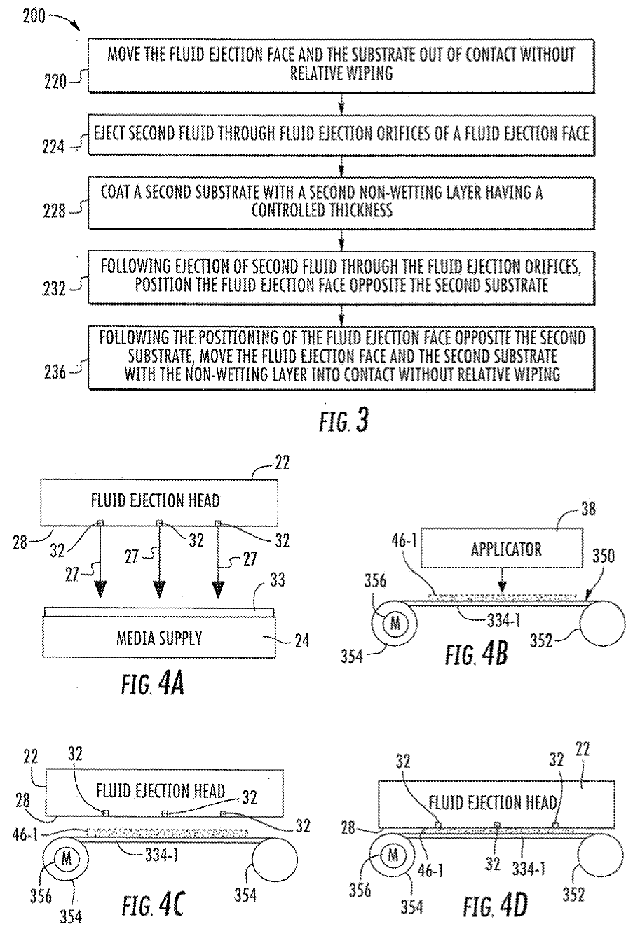

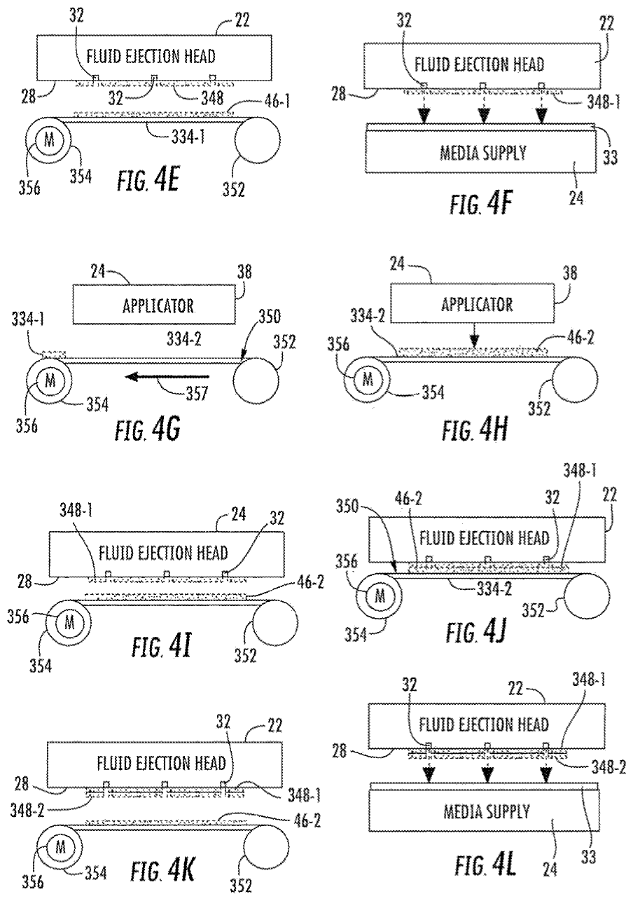

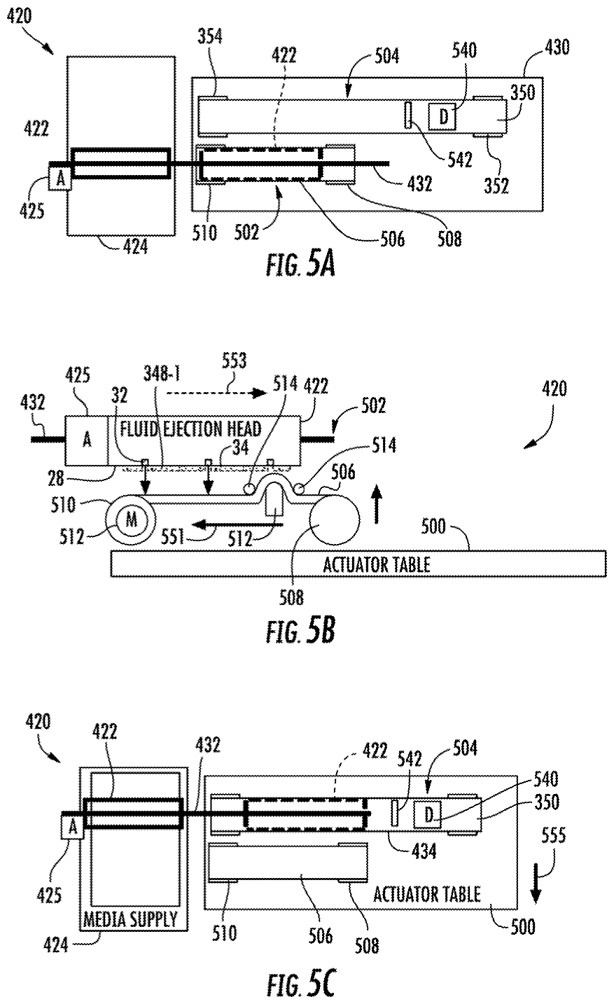

FIGS. 4A-4L are side views schematically illustrating one example use of methods 100 and 200 with respect to an example substrate provided as part of a wound web. FIGS. 4A-4L illustrate one example of how a web of non-absorbent material may be wound and unwound such that clean or unused portions of the web are coated with the non-wetting layer and brought into contact with the fluid ejection face each time that the fluid ejection face is being serviced or different portions of the fluid ejection face are being serviced with the application of the non-wetting layer. Because an unused substrate coated with the non-wetting layer is used each servicing instance, the likelihood of the fluid ejection face being contaminated with fluid deposited upon the substrate from a prior servicing instance is reduced.

FIG. 4A illustrates the ejection of fluid onto medium 33 supported by media supply 24 per block 104 as described above with respect to method 100. FIG. 4B illustrates the coating of a first substrate 334-1 with a layer 46-1 of a non-wetting material per block 108. As shown by FIG. 4B, substrate 334-1 comprises a first portion of a larger web 350 having a first end portion wound about a supply roll 352 and a second end portion wound about a take-up roll 354. A motor 356, serving as a web drive, may be used to selectively wind up web 350 about roll 354, advancing web 350.

FIG. 4C illustrates the positioning of the fluid ejection face 28 and the non-wetting layer 46-1 carried by substrate 334-1 opposite one another per block 112. FIG. 4D illustrates the movement or positioning of the fluid ejection face 28 and the non-wetting layer 46-1 supported by substrate 334-1 into contact with one another without relative wiping per block 116. FIG. 4E illustrates the separation of fluid ejection face 28 and non-wetting layer 46 supported on substrate 334 without relative wiping per block 220. As shown by FIG. 4E, following such separation, a portion of layer 46 remains stamped on fluid ejection face 28 about nozzles 34, forming non-wetting layer 348-1. Due to the non-wiping action and the thickness of layer 46, non-wetting layer 348-1 does not project into, or minimally projects into, orifices 32.

FIG. 4F illustrates a fluid ejection or printing operation being carried out following the treatment of fluid ejection face 28 per block 224. During and following such fluid ejection, non-wetting layer 348-1 resists adherence of the fluid being ejected through face 28, inhibiting the puddling or collection of fluid or contaminants. As a result, fluid ejection consistency and quality may be enhanced.

Over time, portions of layer 348-1 may thin or may be completely removed. FIGS. 4G-4K illustrate the replenishment of layer 348-1 with new additional non-wetting material. FIG. 4I illustrates the actuation of motor 356 to wind take-up roll 354 and unwind supply roll 352, advancing web 350 in the direction indicated by arrow 357. This advancement positions a new unused portion of web 350 opposite to applicator 38, wherein the previously used portion of web 350, previously providing substrate 334-1 wound about roll 354 or is moved to a position no longer opposite to applicator 38. The new portion of web 350 positioned directly opposite applicator 38 serves as a second substrate 334-2 for supporting a non-wetting layer for treating fluid ejection face 28.

FIG. 4H illustrates applicator 38 applying or coating substrate 334-2 with a second non-wetting layer 46-2 having a controlled thickness per block 228. Similar to the coating described above respect to block 108 or block 228, the coating of substrate 334-2 may occur concurrently with, before or after the ejection of fluid in shown in FIG. 4F. In one implementation, substrate 334-2 is coated with layer 46-2 after the ejection of fluid in block 104 and immediately prior to the servicing of fluid ejection face 28 (without any intervening fluid ejections through orifices 32 onto medium 33) so as to reduce evaporation and drying or solidification of layer 46-2 prior to application of the material of layer 46-2 to face 28.

FIG. 4I illustrates the positioning of fluid ejection face 28, with any remaining portions of the previously applied non-wetting layer 348-1, and the positioning of substrate 334-2, with its supported non-wetting layer 46-2, directly opposite to one another per block 232. Such positioning occurs without any contact between surface 28 or layer 348-1 and substrate 334-2 or non-wetting layer 46-2 so as to avoid any wiping action. FIG. 4J illustrates the movement or positioning of the fluid ejection face 28 and the non-wetting layer 46-2 supported by substrate 334-2 into contact with one another without relative wiping per block 236. In one implementation, layer 46-2 is moved into contact with fluid ejection face 28 without movement of face 28 or layer 46-2 in a plane parallel to the plane of face 28 or the plane of face 28. In one implementation, fluid ejection face 28 and layer 46-2 are moved towards one another in directions perpendicular to fluid ejection face 28 and/or the surface of substrate 334-2. The controlled thickness of layer 46-2 and the non-wiping contact of face 28 and layer 46-2 are such that the extent to which the non-wetting material of layer 46-2 is pushed into or enters orifices 32 is reduced.

Similar to FIG. 4E, FIG. 4K illustrates the separation of fluid ejection face 28 and non-wetting layer 46-2 supported on substrate 334-2 without relative wiping. As shown by FIG. 4K, following such separation, a portion of layer 46-2 remains stamped on the previously formed layer 348-1 and/or upon fluid ejection face 28 about nozzles 34, forming non-wetting layer 348-2. Due to the non-wiping action and the thickness of layer 46-2, non-wetting layer 348-2 does not or minimally projects into orifices 32.

Similar to FIG. 4F, FIG. 4L illustrates a fluid ejection or printing operation being carried out following the treatment of fluid ejection face. During and following such fluid ejection, non-wetting layer 348-1, as supplemented by non-wetting layer 348-2, resists adherence of the fluid being ejected through orifices 32 of face 28, inhibiting the puddling or collection of fluid or contaminants. As a result, fluid ejection consistency and quality may be enhanced. The servicing of fluid ejection face 28 illustrated in FIGS. 4I-4K be repeated throughout the life of the fluid ejection system to maintain fluid ejection performance.

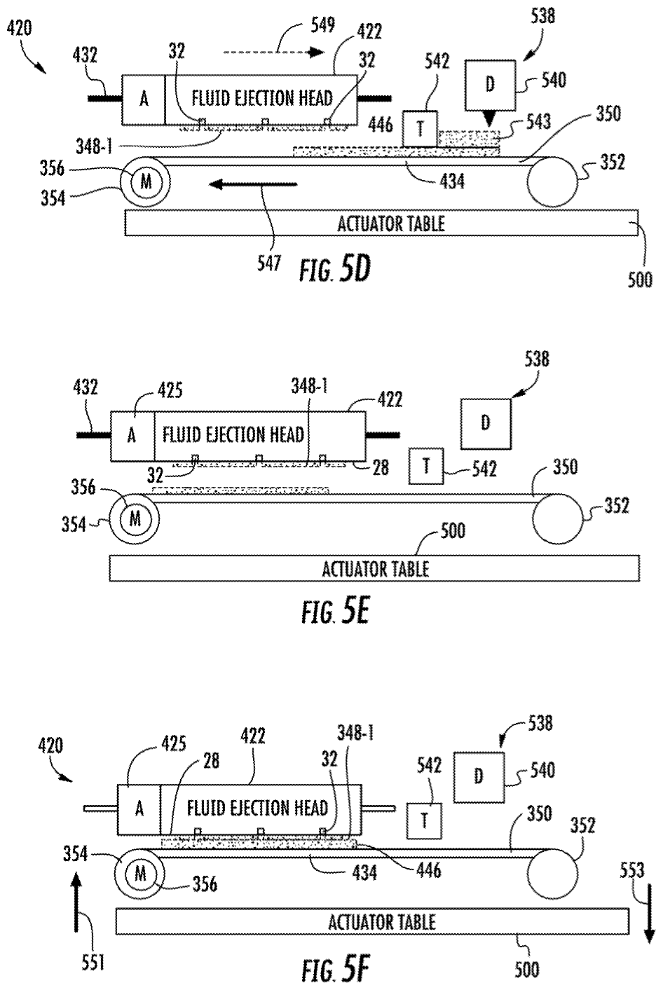

FIGS. 5A-5F illustrate portions of an example fluid ejection system 420 during example fluid ejection and servicing operations. FIGS. 5A-5F illustrate the servicing of a fluid ejection head through purging/spitting, wiping and non-wetting layer application servicing operations. FIGS. 5A-5F illustrate an example of how a servicing station in a printer or other fluid ejection system may carry out each of the aforementioned servicing operations.

As shown by FIGS. 5A, 5B and 5D, fluid ejection system 420 comprises fluid ejection head 422, actuator 425, media supply 424 and service station 430. Fluid ejection head 422 and media supply 424 are similar to fluid ejection head 22 and media supply 24 described above. Fluid ejection head 422 is movably supported along a guide 432 for movement between a fluid ejection or printing position opposite to media supply 424 and a servicing position opposite to service station 430. In one implementation, guide 432 comprises a guide rod along which fluid ejection head 422 slides. In other implementations, fluid ejection head 422 movably supported for movement between media supply 424 and service station 430 in other manners.

Actuator 425 comprises a device operably coupled to fluid ejection head 422 so as to translate fluid ejection head 422 along guide 432 between the fluid ejection position and the servicing position. In one implementation, actuator 425 comprises a carriage supporting fluid ejection head 422. In one implementation, actuator 425 comprises a motor that drives a flexible cable about a pair of pulleys or guides and along guide 432, wherein a portion of the flexible cable is attached to the carriage, supporting fluid ejection head 422, and wherein the motor controllably drives the cable to translate fluid ejection head 422 along guide 432.

Service station 430 carries out various servicing operations on fluid ejection head 422. Service station 430 comprises actuator table 500, purging and wiping station 502 and non-wetting layer application station 504. Actuator table 500 comprises a movable platform supporting stations 502 and 504. Actuator table 500 incorporates actuators to move stations 502 and 504 in multiple directions so as to selectively move stations 502 and 504 relative to fluid ejection head 422. In one implementation, actuator table 500 may utilize motors, hydraulic or pneumatic piston-cylinder assemblies or electric motors to move the platform supporting stations 502 and 504.

As shown by FIG. 5B, purging and wiping station 502 comprises a web 506 of a fluid absorbent material provided and supported by a supply roll 508 and a take-up roll 510 which is rotatably driven by a motor 512. Rolls 508 and 510 support a span of web 506 for receiving fluid being purged or spit from fluid ejection head 422 through orifices 32.

Purging and wiping station further includes a wiper 512 and a pair of rollers 514. Web 506 is guided by rollers 514 and wraps about wiper 512 between rolls 508, 510. Wiper 512 presses a portion of web 506 into contact with fluid ejection face 28 to wipe fluid ejection face 28 as fluid ejection head 422 and/or web 506 are transversely moved relative to one another. For example, in one implementation, web 506 may be pulled in the direction indicated by arrow 551 by the winding of the web 506 about roller 510 by motor 512. Movement of web 506 over wiper 512 to and against fluid ejection face 28 wipes fluid ejection face 28. In some implementations, fluid ejection head 422 may be additionally moved in the direction indicated by arrow 553 relative to web 506 to facilitate such wiping.

In some implementations, wiper 512 is stationary. In other implementations, wiper 512 may be vertically movable to raise and lower portions of web 506 into and out of contact with fluid ejection face 28. In yet other implementations, wiper 512 may be a rubber or elastomeric wiper blade supported independent of web 506, to a side of web 506, so as to directly contact and wipe fluid ejection face 28 during a wiping service operation.

Non-wetting layer application station 504 applies a layer of a non-wetting material on fluid ejection face 28, either directly on face 28 or indirectly on face 28 (on a previously applied layer of non-wetting material). Non-wetting layer application station 504 is similar to the system shown in FIG. 4H and described above except that station 504 is specifically illustrated as comprising applicator 538 in place of applicator 38. As described above, station 504 comprises a web 350 supported by supply roll 352 and take-up roll 354 which is rotatably driven by a motor 356, serving as a web drive.

Applicator 538 comprises dispenser 540 and thinner 542. Dispenser 540 comprises a device that deposits a mass or dose of non-wetting material onto a portion of web 350 serving as substrate 434. In one implementation, dispenser 540 may comprise a reservoir and a valve that is selectively opened and closed so as to permit the flow of the non-wetting material onto a substrate 434. In yet another implementation, dispenser 540 may comprise a jetting or spraying apparatus to control the deposition of the non-wetting material on substrate 434. In one implementation, the dose of the deposited non-wetting material has a thickness greater than the controlled thickness provided by thinner 542.

Thinner 542 controls the thickness of the non-wetting material on substrate 434 to form the non-wetting layer 446. FIG. 6 illustrates thinner 642, one example of thinner 542. Thinner 642 comprises a doctor blade 644 having a tip 645 spaced from the surface of substrate 434 by the controlled distance. The dose of non-wetting material 543 is deposited on a first side of blade 644, wherein blade 644 and/or substrate 434 are moved such that non-wetting material 543 is driven between blade 644 and substrate 434 so as to have the controlled thickness forming layer 446. In the example illustrated, web 350 is driven in the direction indicated by arrow 647 to form layer 446.

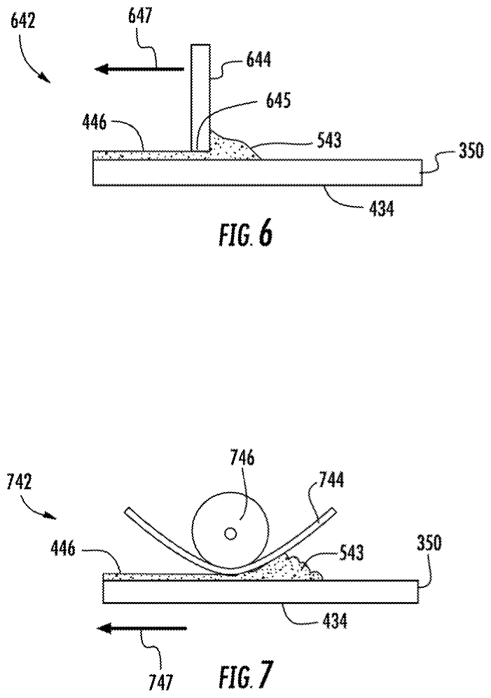

FIG. 7 illustrates thinner 742, another example of thinner 542. Thinner 742 comprises a pressure roller for controlling the thickness of the non-wetting layer. In the example illustrated, thinner 742 comprises pressure web 744 and pressure roller 746. Pressure roller 746 presses pressure web 744 against the non-wetting material 543 deposited by dispenser 540 to restrict the flow of the non-wetting material 543 past web 744 and roller 746. The dose of non-wetting material 543 is deposited on a first side of roller 746, wherein roller 746 and/or substrate 434 are moved such that non-wetting material 543 is driven between web 744 and substrate 434 so as to have the controlled thickness forming layer 446. In the example illustrated, web 350 is driven in the direction indicated by arrow 747 to form layer 446.

As discussed above, the thickness of layer 446 is controlled such that layer 446, when stamped against fluid ejection face 28, does not fill or enter orifices 32. In one implementation, applicator 538 provides the non-wetting layer 446 with a thickness of no greater than 3 μm. In one implementation, applicator 538 provides the non-wetting layer 446 with a thickness of no greater than 1 μm. In one implementation, applicator 538 provides a non-wetting layer 446 having a thickness of no greater than 1/10 of an average diameter of the orifices 32. In one implementation in which the orifice openings have an average diameter of 25 micrometres, applicator 538 provides layer 446 with the controlled thickness of no greater than 1 μm.

Referring back to FIGS. 5A-5F, the operation of the fluid ejection system 420 is illustrated. FIG. 5A illustrates the positioning of fluid ejection head 422 opposite to media supply 424 by actuator 425. In this position, fluid ejection head 422 ejects fluid through orifices 32 (shown in FIG. 5B) onto a print medium supported by media supply 424 as described above with respect to block 224 in FIG. 3. In the example illustrated, fluid ejection face 28 of fluid ejection head 422 has been previously coated with a non-wetting layer 348-1 in a fashion similar to that described above in FIGS. 4B-4E.

FIG. 5B illustrates the servicing of fluid ejection head 422. FIG. 5B illustrates fluid ejection head 422 after head 422 has been moved by actuator 425 along guide 432 to a position (shown in broken lines in FIG. 5A) directly opposite to purging and wiping station 502. FIG. 5B further illustrates the purging or spitting of fluid through orifices 32 onto the absorbent web 506 to clear orifices 32. FIG. 5B further illustrates wiper 512 pressing portions of web 506 into contact with fluid ejection face 28 (and layer 348-1). In the example illustrated, the entire actuator table 500 is lifted to thereby lift wiper 512. In other implementations, wiper 512 may be lifted relative to actuator 500 to move portions of web 506 into wiping contact with fluid ejection face 28. While portions web 506 are being pressed against fluid ejection face 28 by wiper 512, fluid ejection head 422 and/or portions web 506 are moved relative to one another. In one implementation, motor 512 rotates take-up roll 510 to advance web 506 in the direction indicated by arrow 551 over wiper 512 and against fluid ejection face 28 to wiper fluid ejection face 28. In another implementation, actuator 425 further moves fluid ejection head 422 in the direction indicated by arrow 553 relative to wiper 512 such that portions web 506 are wiped against fluid ejection face 28. In yet other implementations, web 506 may be driven in the direction indicated by arrow 551 while fluid ejection head 422 is also moved in the direction indicated by arrow 553 to carry out wiping a fluid ejection face 28.

FIG. 5C illustrates the positioning of fluid ejection head 422 opposite to non-wetting layer application station 504. In the example illustrated, actuator table 500 is driven in the direction indicated by arrow 555 to locate fluid ejection head 422 over substrate 434 provided by web 350 (as shown in FIG. 5). FIG. 5D illustrates the coating of substrate 434 with a layer 446 of non-wetting material 543, wherein the layer 446 has a controlled thickness. In the example illustrated, dispenser 540 deposits the dose of non-wetting material 543 on a first side of thinner 542 and motor 356 drives take-up roll 354 to advance web 350 in the direction indicated by arrow 547. The thicker mass of non-wetting material 543 on a first side of thinner 542 is thinned to the controlled thickness of layer 446 on a second opposite side of thinner 542. As shown by FIG. 5E, motor 356 continues to advance substrate 434 and the carried layer 446 of non-wetting material to a position opposite to fluid ejection face 28 of fluid ejection head 422. In some implementations, such positioning may be further facilitated by movement of fluid ejection head 422 by actuator 425 in the direction indicated by arrow 549 (shown in FIG. 5D).

As shown by FIG. 5F, following the positioning of layer 446 and fluid ejection face 28 opposite to one another, actuator table 500 is lifted in the direction indicated by arrow 551 to raise layer 446 into contact with fluid ejection face 28 and any existing portions of layer 348-1 on fluid ejection face 28 without wiping of fluid ejection face 28 or layer 348-1. As a result, portions of layer 446 become stamped onto fluid ejection face 28 to add additional non-wetting material to fluid ejection face 28. Following such stamping, actuator table 500 may be lowered in the direction indicated by arrow 553 and fluid ejection head 422 may once again be moved by actuator 425 to the position shown in FIG. 5A opposite to a print medium supported by media supply 424, ready for ejecting fluid onto the print medium supported by media supply 424.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A fluid ejection system comprising:
a fluid ejection head having a fluid ejection face through which fluid ejection orifices extend;
a media supply to supply a medium for receiving fluid ejected through the fluid ejection orifices; and
a service station comprising:
a substrate;
an applicator to coat the substrate with a non-wetting layer having a controlled thickness; and
an actuator to move the substrate with the non-wetting layer into contact with the fluid ejection face without wiping the fluid ejection face.

2. The fluid ejection system of claim 1 further comprising:
a web supported between a supply roll and a take-up roll, the web providing the substrate; and
a web drive to advance the web.

3. The fluid ejection system of claim 1, wherein the applicator comprises a pressure roller to be rotatably driven opposite the substrate to control the thickness of the non-wetting layer.

4. The fluid ejection system, of claim 1, wherein the applicator comprises a doctor blade to be positioned opposite the substrate to control the thickness of the non-wetting layer.

5. The fluid ejection system of claim 1, wherein the servicing station further comprises a wiper to wipe the fluid ejection face.

6. The fluid ejection system of claim 1, wherein the servicing station further comprises an absorbent web to receive fluid ejected through the fluid ejection orifices.

7. The fluid ejection system of claim 1 further comprising a carriage to move the fluid ejection face from a first position opposite the medium provided by the media supply to a second position opposite the substrate.

8. A fluid ejection system service station comprising:
a web supported between a supply roll and a take-up roll, the web providing a substrate;
an applicator to coat the substrate with a non-wetting layer having a controlled thickness; and
an actuator to move the substrate with the non-wetting layer into contact with a fluid ejection face without wiping the fluid ejection face.

9. The fluid ejection system service station of claim 8, wherein the applicator comprises a pressure roller to be rotatably driven opposite the substrate to control the thickness of the non-wetting layer.

10. The fluid ejection system service station of claim 8, wherein the applicator comprises a doctor blade to be positioned opposite the substrate to control the thickness of the non-wetting layer.

11. The fluid ejection system service station of claim 8, wherein the service station further comprises a wiper to wipe the fluid ejection face.

12. The fluid ejection system service station of claim 8, wherein the service station further comprises an absorbent web to receive fluid ejected through fluid ejection orifices.

13. A fluid ejection head service method comprising:
ejecting fluid through fluid ejection orifices of a fluid ejection face;
coating a substrate with a non-wetting layer having a con oiled thickness;
following the ejection of the fluid through the fluid ejection orifices, positioning the fluid ejection face and the substrate opposite one another; and
following the positioning of the fluid ejection face and the substrate opposite one another, moving the fluid ejection face and the substrate with the non-wetting layer into contact without relative wiping.

14. The method of claim 13 further comprising:
moving the fluid ejection face and the substrate out contact without relative wiping;
coating a second substrate with a second non-wetting layer having a controlled thickness; and
following ejection of second fluid through the fluid ejection orifices, positioning the fluid ejection face opposite the second substrate; and
following the positioning of the fluid ejection face opposite the second substrate, moving the fluid ejection face and the second substrate with the second non-wetting layer into contact without relative wiping.

15. The method of claim 14 further comprising advancing a web having a first portion providing the substrate and a second portion providing the second substrate to position the fluid ejection face opposite the second substrate.
